(19) United States
(12) Patent Application Publication
(10) Pub. No.: US 2018/0283394 A1
(43) Pub. Date: Oct. 4, 2018

(54) COMPRESSOR HOUSING FOR TURBOCHARGER

(71) Applicants: OTICS CORPORATION, Nishio-city, Aichi (JP); TOYOTA JIDOSHA KABUSHIKI KAISHA, Toyota-shi, Aichi-ken (JP)

(72) Inventors: Tomoki MIYOSHI, Aichi (JP); Tomoyuki ISOGAI, Aichi (JP); Koichi YONEZAWA, Aichi (JP)

(73) Assignees: OTICS CORPORATION, Nishio-city, Aichi (JP); TOYOTA JIDOSHA KABUSHIKI KAISHA, Toyota-shi, Aichi (JP)

(21) Appl. No.: 15/545,278

(22) PCT Filed: Nov. 5, 2015
(86) PCT No.: PCT/JP2015/081191

§ 371 Date: Jul. 20, 2017

(30) Foreign Application Priority Data
Feb. 25, 2015 (JP) 2015-034670
Jun. 30, 2015 (JP) 2015-112922

(51) Int. Cl. F04D 29/16; F02C 6/12; F04D 29/42; F04D 29/62

(52) U.S. Cl. CPC F04D 29/162; F02C 6/12; F04D 29/4213; F01D 11/122; F05D 2220/40; F05D 2260/37; F04D 29/624

(57) ABSTRACT

A compressor housing for a turbocharger including an intake port, a scroll chamber, and a shroud part. The shroud part includes an annular abradable seal, and an annular abradable seal fixing part. The abradable seal fixing part includes a press-fitting recessed portion into which the abradable seal is press-fitted, and a grooved portion formed at a forward side of the press-fitting recessed portion with respect to a press-fitting direction of the abradable seal. The abradable seal includes a press-fit abutting portion press-fitted into the press-fitting recessed portion, abutting against an inner circumferential surface of the press-fitting recessed portion, and a bulging portion at a forward side of the press-fit abutting portion with respect to the press-fitting direction. The outside diameter of the bulging portion is larger than the inside diameter of the press-fitting recessed portion but smaller than the inside diameter of the grooved portion.

### TECHNICAL FIELD

The present invention relates to a compressor housing for a turbocharger.

### BACKGROUND ART

A compressor for use in a supercharger such as a turbocharger of an automobile includes a compressor housing that is configured to be able to house an impeller, and includes an intake port for sucking air toward the impeller, a scroll chamber for introducing air discharged by the impeller thereinto, the scroll chamber being formed in a circumferential direction at an outer circumferential side of the impeller, and a shroud surface opposed to the impeller.

With the compressor configured as above, compression efficiency of the compressor can be increased by minimizing a gap between blades of the impeller and the shroud surface of the compressor housing.

However, if the gap is decreased, the impeller may be damaged, for example, when the impeller blades come into contact with the shroud surface of the compressor housing due to vibrations, a runout of an impeller rotation shaft, or the like.

Thus, in one conventionally proposed structure, an abradable seal made of a resin or the like softer than the impeller blades is attached to a portion forming the shroud surface of the compressor housing (Patent Document 1).

In this case, even if the impeller blades come into contact with the shroud surface of the compressor housing due to vibrations, a runout of the impeller rotation shaft, or the like, only the abradable seal attached to the portion forming the shroud surface is abraded, leaving the impeller undamaged and the gap between the impeller blades and the shroud surface of the compressor housing is kept small.

### PRIOR ART DOCUMENT

### Patent Document

Patent Document 1: JP-A-09-170442

### SUMMARY OF THE INVENTION

### Problem to be Solved by the Invention

However, in Patent Document 1, the abradable seal is fixed to the shroud part with a screw member. Also, the abradable seal is fixed to the shroud part with a snap ring and the like. In these cases, there is a problem in that a structure for fixing the abradable seal becomes complicated and parts count increases, resulting in a disadvantage in terms of cost.

On the other hand, the abradable seal is also fixed with a simple configuration by press-fitting or otherwise fitting of the abradable seal into the shroud part. However, if the abradable seal is press-fitted into the shroud part, a press-fit portion of the abradable seal is subjected to compressive stress, which causes deformation of the abradable seal due to a creep phenomenon and produces a phenomenon in which an interference between the abradable seal and the shroud part decreases. Consequently, holdability of the shroud part for the abradable seal may decrease. Particularly under operation of the compressor, the abradable seal is exposed to high-temperatures for a long time, so that this phenomenon occurs more prominently.

The present invention has been made in view of the above background to provide a compressor housing for a turbocharger in which an abradable seal can be fixed reliably with a simple configuration.

### Means for Solving the Problem

One aspect of the present invention provides a compressor housing for a turbocharger configured to be able to house an impeller, the compressor housing including: an intake port for sucking air toward the impeller; a scroll chamber for introducing air discharged by the impeller thereinto, the scroll chamber being formed in a circumferential direction at an outer circumferential side of the impeller; and a shroud part having a shroud surface opposed to the impeller, wherein the shroud part includes an annular abradable seal, an inner circumferential surface of which serves as the shroud surface, and an annular abradable seal fixing part to which the abradable seal is fixed, the abradable seal fixing part includes a press-fitting recessed portion into which the abradable seal is press-fitted, and a grooved portion recessively formed radially outwardly in a circumferential direction at a forward side of the press-fitting recessed portion with respect to a press-fitting direction of the abradable seal, and the abradable seal includes a press-fit abutting portion that is press-fitted into the press-fitting recessed portion in an axial direction and abuts against an inner circumferential surface of the press-fitting recessed portion, and a bulging portion provided in a manner opposing to the grooved portion at a forward side of the press-fit abutting portion with respect to the press-fitting direction, the bulging portion having an outside diameter that is larger than an inside diameter of the press-fitting recessed portion of the abradable seal fixing part, but smaller than an inside diameter of the grooved portion.

### Effects of the Invention

In the compressor housing for a turbocharger, the abradable seal is press-fitted into the press-fitting recessed portion of the abradable seal fixing part in the axial direction and the press-fit abutting portion abuts against the inner circumferential surface of the press-fitting recessed portion while the bulging portion located at a forward side of the press-fit abutting portion with respect to the press-fitting direction is fixed to the abradable seal fixing part, opposing to the grooved portion of the abradable seal fixing part. At an initial stage of assembly, the press-fit abutting portion of the abradable seal is press-fitted in the press-fitting recessed portion, and the diameter of the press-fit abutting portion is reduced by compressive stress from the inner circumferential surface of the press-fitting recessed portion, thereby providing a sufficient interference between the abradable seal and the inner circumferential surface of the press-fitting recessed portion, so that the abradable seal is held by the abradable seal fixing part. Furthermore, since the bulging portion of the abradable seal has an outside diameter larger than the inside diameter of the press-fitting recessed portion of the abradable seal fixing part but smaller than the inside diameter of the grooved portion, the bulging portion does not abut on the abradable seal fixing part. Therefore, a hollow space is formed in the radial direction between the bulging portion and an inner wall surface of the grooved portion. Consequently, whereas the press-fit abutting portion is subjected to compressive stress from the inner circumferential surface of the press-fitting recessed portion in the abradable seal fixing part, the bulging portion receives no compressive stress from the abradable seal fixing part after assembled. And, in the press-fitting direction (axial direction), the bulging portion is located at a forward side of the press-fit abutting portion that abuts on the inner circumferential surface of the press-fitting recessed portion. Thus, the bulging portion is certainly caught by the grooved portion to exert an anchoring effect. This enables to prevent axial movement of the abradable seal that is press-fitted into the press-fitting recessed portion.

Furthermore, after assembled, the press-fit abutting portion continuously receives compressive stress from the inner circumferential surface of the press-fitting recessed portion, so that the press-fit abutting portion develops deformation (plastic deformation) due to a creep phenomenon, whereas the bulging portion receives no compressive stress from the abradable seal fixing part after assembled, so that the bulging portion develops no deformation due to a creep phenomenon. Consequently, even if the deformation of the press-fit abutting portion due to a creep phenomenon reduces the interference between the abradable seal and the inner circumferential surface of the press-fitting recessed portion to thereby reduce the holdability for the abradable seal at the press-fit abutting portion, it is possible to secure and maintain to the holdability for the abradable seal by the anchoring effect of the bulging portion.

Also, in the compressor housing, the abradable seal is fixed by press-fitting it into the press-fitting recessed portion of the abradable seal fixing part. Thus, the compressor housing needs no part for fixing the abradable seal as conventional. This enables to fix the abradable seal with a simple configuration without increasing parts count. As a result, production efficiency can be enhanced while curbing costs.

Thus, according to the present invention, it is possible to provide a compressor housing for a turbocharger which enables to sufficiently and reliably fix an abradable seal and maintain holdability for the abradable seal with a simple configuration.

### BRIEF DESCRIPTION OF THE DRAWINGS

FIG. 1 is a sectional view of a turbocharger equipped with a compressor housing for a turbocharger according to Embodiment 1.

FIG. 2 is an exploded sectional view of the compressor housing for a turbocharger according to Embodiment 1.

FIG. 3 is an exploded sectional view of a shroud part according to Embodiment 1.

FIG. 4 is a partially enlarged view of the shroud part in FIG. 2.

FIG. 5 is a sectional view for describing an assembly method of the shroud part according to Embodiment 1.

FIG. 6 is a sectional view for describing the assembly method of the shroud part according to Embodiment 1.

FIG. 7 is a partially enlarged view of a shroud part according to Embodiment 2.

FIG. 8 is a partially enlarged view of a shroud part according to Embodiment 3.

FIG. 9 is an exploded sectional view of a compressor housing for a turbocharger according to Embodiment 4.

FIG. 10 is a sectional view of a turbocharger equipped with a compressor housing for a turbocharger according to Embodiment 5.

FIG. 11 is a partially enlarged view of a shroud part in FIG. 10.

FIG. 12 is a sectional view for describing a method of assembling the shroud part according to Embodiment 5.

FIG. 13 is a sectional view for describing the method of assembling the shroud part according to Embodiment 5.

FIG. 14 is a sectional view of a turbocharger equipped with a compressor housing for a turbocharger according to a variation of Embodiment 5.

FIG. 15 is a partially enlarged view of a shroud part according to Embodiment 6.

FIG. 16 is a partially enlarged view of a shroud part according to Embodiment 7.

### MODE FOR CARRYING OUT THE INVENTION

The aforesaid compressor housing for a turbocharger can be used for an automobile.

In the aforesaid compressor housing, an outside diameter of the press-fit abutting portion before being press-fitted into the abradable seal fixing part can be determined, in consideration of holdability for the abradable seal, assemblability, and the like. For example, in the abradable seal, the outside diameter of the press-fit abutting portion can be configured to be equal to the outside diameter of the bulging portion before being press-fitted into the abradable seal fixing part and become smaller than the outside diameter of the bulging portion after being press-fitted into the abradable seal fixing part. This enables easy and reliable press-fitting of the press-fit abutting portion of the abradable seal into the press-fitting recessed portion of the abradable seal fixing part to allow the abradable seal to be fixed securely to the abradable seal fixing part.

Also, in the compressor housing, the abradable seal can be configured such that a cut portion cut radially inwardly is formed between the bulging portion and the press-fit abutting portion. In this case, since the cut portion is formed between the bulging portion and the press-fit abutting portion, even if the diameter of the press-fit abutting portion is reduced by compressive stress from the press-fitting recessed portion, the bulging portion is prevented from following the diameter reduction of the press-fit abutting portion and getting deformed accordingly. Consequently, in a boundary portion between the bulging portion and the cut portion, a bulging amount on the basis of the press-fit abutting portion is maintained, allowing the bulging portion to exhibit an anchoring effect sufficiently.

Also, in the compressor housing, the cut portion may be formed in a circumferential direction along a rear-side wall surface of the grooved portion with respect to the press-fitting direction. In this case, because the boundary portion between the bulging portion and the cut portion is formed in the circumferential direction along the rear-side wall surface of the grooved portion, the boundary portion sufficiently exhibits an anchoring effect for the rear-side wall surface of the grooved portion with respect to the press-fitting direction.

Also, the compressor housing may include an axial-direction restricting part for restricting a press-fitting position of the abradable seal in the axial direction by abutment of the abradable seal against a front-side wall surface of the grooved portion with respect to the press-fitting direction, and the bulging portion may be formed between the press-fit abutting portion and the axial-direction restricting part. In this case, the grooved portion forms a hollow space between the bulging portion and the abradable seal fixing part such that the bulging portion will not receive compressive stress from the abradable seal fixing part and restricts the press-fitting position of the abradable seal. Therefore, it is not necessary to separately provide means for restricting the press-fitting position of the abradable seal, and a configuration of the shroud part can be simplified.

With the configuration disclosed in Patent Document 1 as one conventional technique, in order to fix the abradable seal to the shroud part, the abradable seal is expanded to a diffuser portion that is not opposed to the impeller, then, fastened and fixed thereto through a screw hole provided in the diffuser portion. Further, a housing recess for housing the head of a screw member is provided on a diffuser surface of the abradable seal in order to avoid the head of the screw member from projecting into a fluid passage from the diffuser surface. However, the housing recess that opens to the fluid passage, affects intake air flowing through the fluid passage to thereby disturb a flow of airflow, which may reduce compression efficiency.

Also, if the housing recess has water or the like in, this may become a cause of corrosion. Thus, it is conceivable to fill the housing recess with putty or the like after placing the head of the screw member in the screw hole. However, such configuration has disadvantages such as increase of manufacturing processes and/or increase of material costs.

Also, since the abradable seal is expanded to the diffuser portion that is a region not opposed to the impeller, to obtain a region for fixing the screw member on the abradable seal, the abradable seal is relatively increased in size. Material for forming the abradable seal is generally more costly than material for forming the compressor housing. Therefore, upsizing of the abradable seal is disadvantageous in terms of cost.

Besides, repetition of thermal expansion and thermal contraction in the abradable seal, or repetition of swelling and recovery from the swelling in a resin forming the abradable seal may also cause deformation due to a creep phenomenon, resulting in reduction of the holdability. Then, when the abradable seal wobbles as a result of the reduction of the holdability, friction occurs in a contact portion between the abradable seal and the shroud part due to vibrations of an engine or the like. This may cause the abradable seal to wear.

Thus, the compressor housing preferably includes a movement restriction member for restricting a movement of the abradable seal in the axial direction, is the movement restriction member being interposed between the abradable seal and the abradable seal fixing part. In this case, in the compressor housing, the abradable seal is mounted by press-fitting into the abradable seal fixing part. Therefore, no fastening member such as a screw member is used to mount the abradable seal, then, a housing recess as conventionally provided to keep part of the fastening member from projecting into a fluid passage from the diffuser surface, needs not be provided. Consequently, a flow of air discharged from the impeller is not disturbed on the diffuser surface. This prevents reduction in compression efficiency. Also, because it is not necessary to fill the housing recess with putty or the like, as conventionally done, the number of manufacturing processes can be reduced, which is advantageous in terms of cost as well. In addition, since it is not necessary to prepare a region for fixing a fastening member to the abradable seal, the abradable seal can be downsized, which is advantageous in terms of cost.

Furthermore, the abradable seal is press-fitted into the press-fitting recessed portion of the abradable seal fixing part in the axial direction and the press-fit abutting portion abuts against the inner circumferential surface of the press-fitting recessed portion while the bulging portion located at a forward side of the press-fit abutting portion with respect to the press-fitting direction is fixed to the abradable seal fixing part, opposing to the grooved portion of the abradable seal fixing part. At an initial stage of assembly, the press-fit abutting portion of the abradable seal is press-fitted in the press-fitting recessed portion, and the diameter of the press-fit abutting portion is reduced by compressive stress from the inner circumferential surface of the press-fitting recessed portion, thereby providing sufficient holdability between the abradable seal and the inner circumferential surface of the press-fitting recessed portion, so that the abradable seal is held by the abradable seal fixing part. Furthermore, since the bulging portion of the abradable seal has an outside diameter larger than the inside diameter of the press-fitting recessed portion of the abradable seal fixing part but smaller than the inside diameter of the grooved portion, the bulging portion does not abut on the abradable seal fixing part. Therefore, a hollow space is formed in the radial direction between the bulging portion and the inner wall surface of the grooved portion. Consequently, whereas the press-fit abutting portion is subjected to compressive stress from the inner circumferential surface of the press-fitting recessed portion in the abradable seal fixing part, the bulging portion receives no compressive stress from the abradable seal fixing part after assembled. And, in the press-fitting direction (axial direction), the bulging portion is located at a forward side of the press-fit abutting portion that abuts on the inner circumferential surface of the press-fitting recessed portion. Thus, the bulging portion is certainly caught by the grooved portion to exert an anchoring effect. This enables to restrict axial movement of the abradable seal that is press-fitted into the press-fitting recessed portion.

Furthermore, after assembled, the press-fit abutting portion continuously receives compressive stress from the inner circumferential surface of the press-fitting recessed portion, so that the press-fit abutting portion develops deformation (plastic deformation) due to a creep phenomenon, whereas the bulging portion receives no compressive stress from the abradable seal fixing part after assembled, so that the bulging portion develops no deformation due to a creep phenomenon. Consequently, even if the deformation of the press-fit abutting portion due to a creep phenomenon reduces the interference between the abradable seal and the inner circumferential surface of the press-fitting recessed portion to thereby reduce the holdability for the abradable seal at the press-fit abutting portion , it is possible to secure the holdability for the abradable seal press-fitted in the press-fitting recessed portion, by the anchoring effect of the bulging portion. The holdability can be maintained for a long period.

Furthermore, the movement restriction member is interposed between the abradable seal and the abradable seal fixing part to restrict the abradable seal from moving in the axial direction. When the press-fit abutting portion is deformed due to a creep phenomenon, the interference between the abradable seal and the press-fitting recessed portion is reduced, or a gap is produced between the abradable seal and the inner circumferential surface of the press-fitting recessed portion especially at low temperatures, so that the holdability for the abradable seal at the press-fit abutting portion is reduced or eliminated. According to the aforesaid configuration, since the movement restriction member restricts axial movements of the abradable seal, the abradable seal is prevented from wobbling in the axial direction and prevented from wear.

The abradable seal fixing part preferably includes a press-fitting direction opposing surface that is opposed to a forward face of the abradable seal with respect to the press-fitting direction. The movement restriction member is preferably made up of a biasing member for biasing the abradable seal rearward in the press-fitting direction, the biasing member being interposed between the press-fitting direction opposing surface and the forward face of the abradable seal. Thus, the abradable seal is biased rearward in the press-fitting direction by the biasing member, so that the bulging portion abuts reliably against a press-fitting direction rear end portion of the grooved portion. As a result, the abradable seal is restricted from moving in the axial direction, and thus, the abradable seal is prevented from wobbling in the axial direction and prevented from wear.

In addition to the biasing member provided as the movement restriction member, the cut portion formed by being cut radially inwardly is preferably formed between the bulging portion and the press-fit abutting portion in the abradable seal. In such configuration, since the cut portion is formed between the bulging portion and the press-fit abutting portion, even if the diameter of the press-fit abutting portion is reduced by compressive stress from the press-fitting recessed portion, the bulging portion is prevented from following the diameter reduction of the press-fit abutting portion and thereby getting deformed. Therefore, in the boundary portion between the bulging portion and cut portion, the bulging amount on the basis of the press-fit abutting portion is maintained. As a result, the biasing member prevents the abradable seal from wobbling in the axial direction and the bulging portion exhibits an anchoring effect sufficiently.

The movement restriction member is preferably formed on an outer circumference of the abradable seal along a corner of the abradable seal fixing part between the grooved portion and the press-fitting recessed portion, and is made up of a bonding layer that bonds together the corner of the abradable seal fixing part and the outer circumference of the abradable seal. Consequently, since the corner between the grooved portion and the press-fitting recessed portion of the abradable seal fixing part is bonded to the outer circumference of the abradable seal via the bonding layer, the abradable seal is prevented from wobbling in the axial direction and prevented from wear.

The bonding layer is preferably made up of an adhesive applied to the cut portion formed between the bulging portion and the press-fit abutting portion by cutting the abradable seal radially inwardly. Thus, the adhesive is held in the cut portion, forming the bonding layer reliably. As a result, since the corner between the grooved portion and the press-fitting recessed portion of the abradable seal fixing part is bonded to the outer circumference of the abradable seal reliably via the bonding layer, the abradable seal is further prevented from wobbling in the axial direction. Furthermore, since the cut portion is formed between the bulging portion and the press-fit abutting portion, even if the diameter of the press-fit abutting portion is reduced by compressive stress from the press-fitting recessed portion, the bulging portion is prevented from following the diameter reduction of the press-fit abutting portion and thereby getting deformed. Therefore, in the boundary portion between the bulging portion and the cut portion, a bulging amount on the basis of the press-fit abutting portion is maintained, allowing the bulging portion to exhibit an anchoring effect sufficiently.

The cut portion is preferably formed in the circumferential direction along the corner of the abradable seal fixing part. Thus, the boundary portion between the bulging portion and the cut portion is formed in the circumferential direction along the corner of the abradable seal fixing part. As a result, the boundary portion sufficiently exhibits an anchoring effect to the rear-side wall surface of the grooved portion with respect to the press-fitting direction.

### EMBODIMENTS

### Embodiment 1

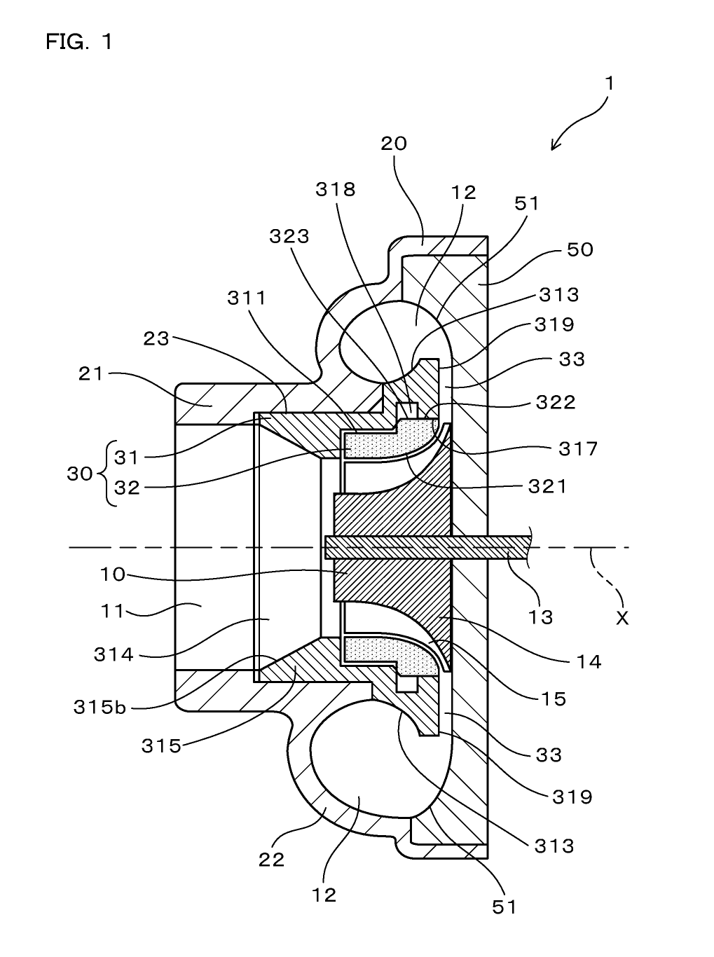

A compressor housing for a turbocharger according to the present embodiment will be described with reference to FIGS. 1 to 5.

A compressor housing 1 for a turbocharger according to the present embodiment (hereinafter also referred to as the “compressor housing 1”) is configured to be able to house an impeller 10 and equipped with a scroll unit 20 and a shroud part 30 as shown in FIG. 1.

The scroll unit 20 includes an intake port 11 for sucking air toward the impeller 10 and a scroll chamber 12 for introducing air discharged by the impeller 10 thereinto. The scroll chamber is formed in a circumferential direction at an outer circumferential side of the impeller 10.

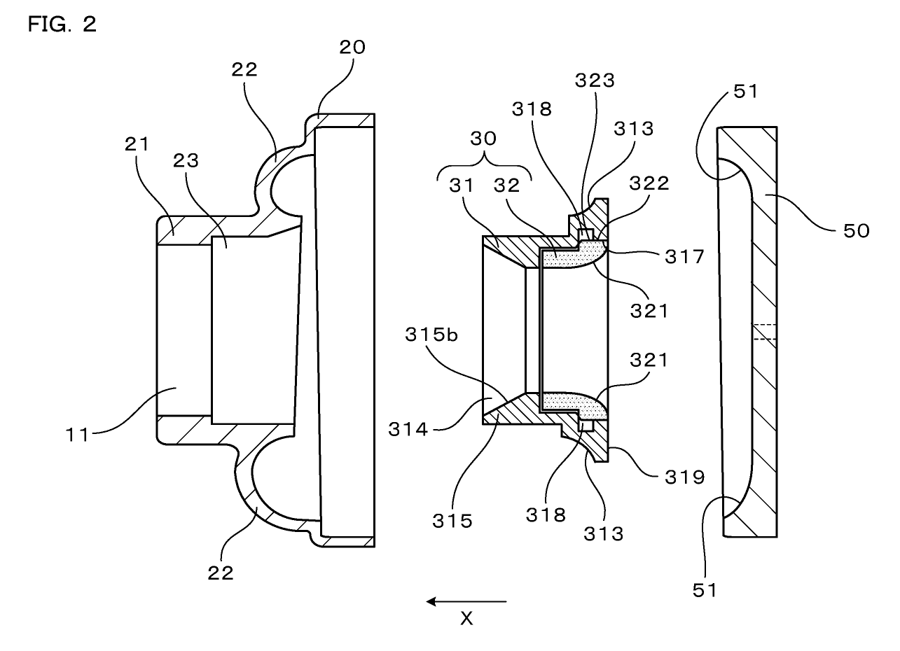

As shown in FIG. 2, the shroud part 30 is made up of an annular, elastically deformable abradable seal 32, an inner circumferential surface 321 of which serves as the shroud surface 321, and an annular abradable seal fixing part 31 to which the abradable seal 32 is fixed.

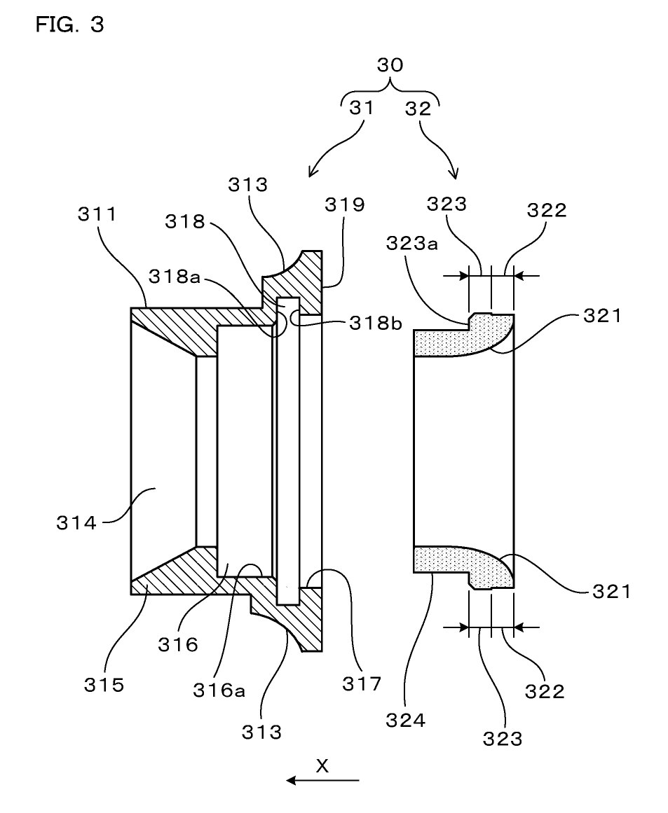

As shown in FIG. 3, the abradable seal fixing part 31 includes a press-fitting recessed portion 317 into which the abradable seal 32 is press-fitted, and a grooved portion 318 recessively formed radially outwardly in the circumferential direction at a forward side of the press-fitting recessed portion 317 with respect to a press-fitting direction X of the abradable seal 32.

The abradable seal 32 includes a press-fit abutting portion 322 that is press-fitted into the press-fitting recessed portion 317 in an axial direction X and abuts against the inner circumferential surface of the press-fitting recessed portion 317. Furthermore, as shown in FIG. 3, the abradable seal 32 includes a bulging portion 323 provided in a manner opposing to the grooved portion 318 at a forward side of the press-fit abutting portion 322 with respect to the press-fitting direction X. The bulging portion has an outside diameter that is larger than an inside diameter of the press-fitting recessed portion 317 of the abradable seal fixing part 31, but smaller than an inside diameter of the grooved portion 318.

As shown in FIGS. 1 and 2, in the scroll unit 20, a back plate unit 50 making up part of the scroll chamber 12 is assembled on a side opposite to the intake port 11.

As shown in these FIGS. 2, the compressor housing 1 forms an outer shell of a compressor (compression machine) for use in a turbocharger (supercharger) of an automobile and is constructed from a combination of the scroll unit 20, the shroud part 30, and the back plate unit 50.

The compressor housing 1 according to the present embodiment will be described in detail below.

As shown in FIGS. 1 and 2, the scroll unit 20 includes the intake port 11, a scroll chamber forming portion 22, and a shroud part press-fitting portion 23. The intake port 11 is formed by a tubular intake port forming portion 21.

The shroud part press-fitting portion 23 has a tubular shape running along an outer circumferential surface 311 of the abradable seal fixing part 31 and is configured such that the shroud part 30 is press-fitted along the axial direction X of a rotating shaft 13 of the impeller 10.

The scroll chamber forming portion 22 is configured to form the scroll chamber 12 in conjunction with a scroll chamber forming portion 313 of the abradable seal fixing part 31 and a scroll chamber forming portion 51 of the back plate unit 50.

As shown in FIG. 3, the shroud part 30 includes the abradable seal fixing part 31 and the abradable seal 32.

As shown in FIGS. 2 and 3, the abradable seal fixing part 31 includes the scroll chamber forming portion 313 configured to form part of the scroll chamber 12, and a tubular press-fitting portion 315 to be press-fitted in the shroud part press-fitting portion 23 of the scroll unit 20 and to form a suction passage 314 communicated with the intake port 11. Furthermore, as shown in FIG. 3, the abradable seal fixing part 31 includes an abradable seal disposition portion 316, the press-fitting recessed portion 317, and the grooved portion 318, which are provided on a side opposite to the suction passage 314 in the tubular press-fitting portion 315. A cylindrical portion 324 of the abradable seal 32 is disposed in the abradable seal disposition portion 316. The press-fit abutting portion 322 of the abradable seal 32 is press-fitted in the press-fitting recessed portion 317. The grooved portion 318 is recessively formed radially outwardly in a circumferential direction at a forward side of the press-fitting recessed portion 317 with respect to the press-fitting direction X of the abradable seal 32. Also, in the abradable seal fixing part 31, a diffuser surface 319, which is a flat surface connecting a shroud surface 321 to be described later with the scroll chamber 12, is formed at the side opposite to the suction passage 314.

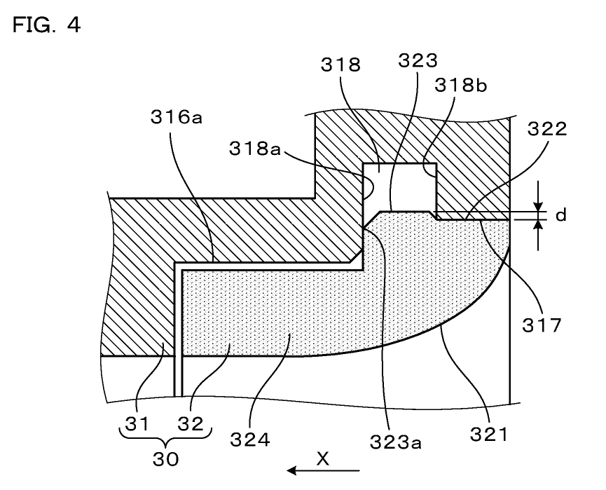

The abradable seal 32 is formed of an elastically deformable member. According to the present embodiment, the abradable seal 32 is made of a polyimide resin. The material for forming the abradable seal 32 is not limited to this, and available materials include Teflon (registered trademark), PPS (polyphenylene sulfide) resin, and PEEK (polyetheretherketone) resin. As shown in FIG. 3, the abradable seal 32 has an annular shape and includes the cylindrical portion 324 formed into a cylindrical shape. The press-fit abutting portion 322 and the bulging portion 323 are provided at a rearward side of the cylindrical portion 324 with respect to the press-fitting direction X (at the side opposite to the intake port 11). The press-fit abutting portion 322 is formed at a rear end of the abradable seal 32 with respect to the press-fitting direction X, by enlarging the diameter radially outwardly. As shown in FIG. 4, the bulging portion 323 is formed between the cylindrical portion 324 and the press-fit abutting portion 322, is continuously adjacent to the forward side of the press-fit abutting portion 322 with respect to the press-fitting direction X, and bulges more outwardly than the press-fit abutting portion 322 in the radial direction.

Symbol d shown in FIG. 4 denotes a bulging amount d of the bulging portion 323 on the basis of the press-fit abutting portion 322, i.e., a value obtained by subtracting a radial length on an outer circumference of the press-fit abutting portion 322 from a radial length on an outer circumference of the bulging portion 323. The bulging amount d can be determined appropriately by taking into consideration of material of the abradable seal 32, an operating environment, press-fit sizes of the abradable seal 32 and the shroud part 30, machining accuracy, and the like such that the bulging portion 323 will bulge into the grooved portion 318 to reliably produce an anchoring effect. For example, the bulging amount d can be determined by taking into consideration of recovery from swelling of the abradable seal 32, permanent growth of aluminum that is a material for forming the abradable seal fixing part 31, a difference in linear thermal expansion between the abradable seal 32 and the abradable seal fixing part 31, dimensional changes of the abradable seal fixing part 31 and the abradable seal 32 due to differences between temperatures inside and outside the compressor housing 1 under operation of the turbocharger, assemble workability of the abradable seal 32 onto the abradable seal fixing part 31, and the like.

As the press-fit abutting portion 322 is press-fitted into the press-fitting recessed portion 317 of the abradable seal fixing part 31 in the axial direction X, the abradable seal 32 is fixed to the abradable seal fixing part 31. Then, the cylindrical portion 324 is disposed in the abradable seal disposition portion 316, with the bulging portion 323 being opposed to the grooved portion 318 of the abradable seal fixing part 31. As shown in FIG. 4, the cylindrical portion 324 does not abut against an inner wall 316a of the abradable seal disposition portion 316. Thus, the position of the abradable seal 32 in the radial direction (direction perpendicular to the axial direction X) with respect to the abradable seal fixing part 31, is determined by abutment of the press-fit abutting portion 322 against the inner circumferential surface of the press-fitting recessed portion 317.

As shown in FIG. 4, an end portion 323a of the bulging portion 323, positioned at the forward side with respect to the press-fitting direction X abuts against a front-side wall surface 318a of the grooved portion 318 of the abradable seal fixing part 31, positioned at the forward side with respect to the press-fitting direction X. Consequently, a press-fitting position of the abradable seal 32 in the press-fitting direction (axial direction X) is restricted. That is, the wall surface 318a serves as an axial-direction restricting part 318a for restricting a press-fitting position of the abradable seal 32 in the axial direction X. The bulging portion 323 is formed between the press-fit abutting portion 322 and the axial-direction restricting part 318a.

As shown in FIG. 1, an inner circumferential surface of the abradable seal 32 is opposed to the impeller 10, forming the shroud surface 321 running along the impeller 10. According to the present embodiment, the entire inner circumferential surface of the abradable seal 32 is opposed to the impeller 10 and thereby forms the shroud surface 321.

Also, as shown in FIG. 1, the impeller 10 is placed on the side of the inner circumferential surface (shroud surface 321) of the abradable seal 32 of the shroud part 30 and mounted rotatably around the rotating shaft 13. Also, the impeller 10 projects plural blades 15 arranged in a circumferential direction from an outer circumferential surface of a hub 14. The plural blades 15 are placed opposing to the shroud surface 321 of the abradable seal 32.

Also, as shown in FIG. 1, the back plate unit 50 that covers the compressor housing 1 from the side opposite to the suction side of the compressor housing 1, is provided at the position opposing to the diffuser surface 319 of the abradable seal fixing part 31. The back plate unit 50 is formed integrally with a bearing housing (not shown) that rotatably supports the rotating shaft 13 of the impeller 10. The back plate unit 50 includes the scroll chamber forming portion 51 configured to form part of the scroll chamber 12.

Also, a diffuser portion 33 for increasing pressure of the air discharged by the impeller 10 is formed between the diffuser surface 319 of the abradable seal fixing part 31 and the back plate unit 50.

In a compressor equipped with the compressor housing 1 for a turbocharger according to the present embodiment shown in FIG. 1, as the impeller 10 rotates, intake air sucked from the intake port 11 through the suction passage 314 is accelerated by the blades 15 of the impeller 10 and sent to the diffuser portion 33. Then, the intake air is increased in pressure by the diffuser portion 33 and sent into the scroll chamber 12.

Next, a method for assembling the compressor housing 1 according to the present embodiment will be described.

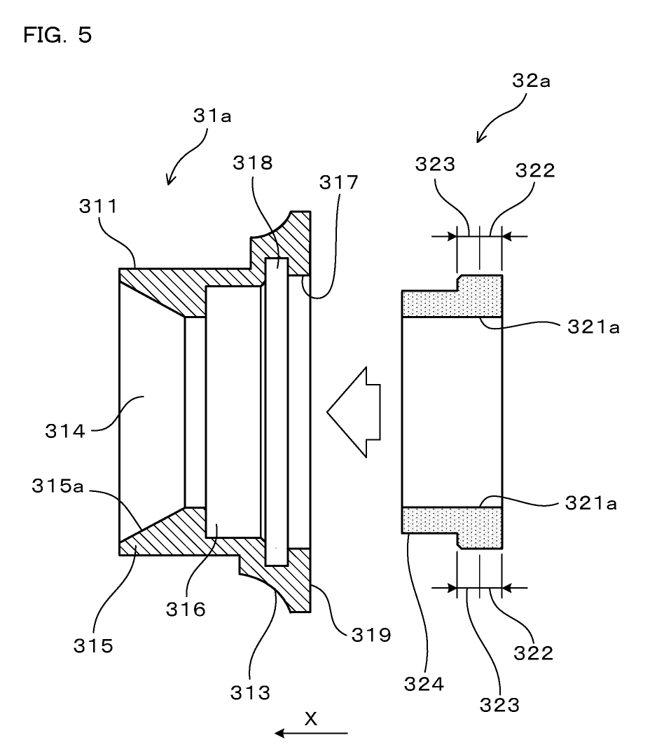

In assembling the compressor housing 1 according to the present embodiment, as shown in FIG. 5, a pre-formed abradable seal 32a to form a shroud surface 321 on the inner circumferential surface of the abradable seal 32, and a pre-formed abradable seal fixing part 31a to form an inner circumferential surface 315a of the tubular press-fitting portion 315 of the abradable seal fixing part 31 are prepared first. Before the pre-formed abradable seal 32a is press-fitted into the pre-formed abradable seal fixing part 31a, an outside diameter of the press-fit abutting portion 322 of the pre-formed abradable seal 32a is equal to the outside diameter of the bulging portion 323, but larger than the inside diameter of the press-fitting recessed portion 317 of the pre-formed abradable seal fixing part 31a and smaller than the inside diameter of the grooved portion 318.

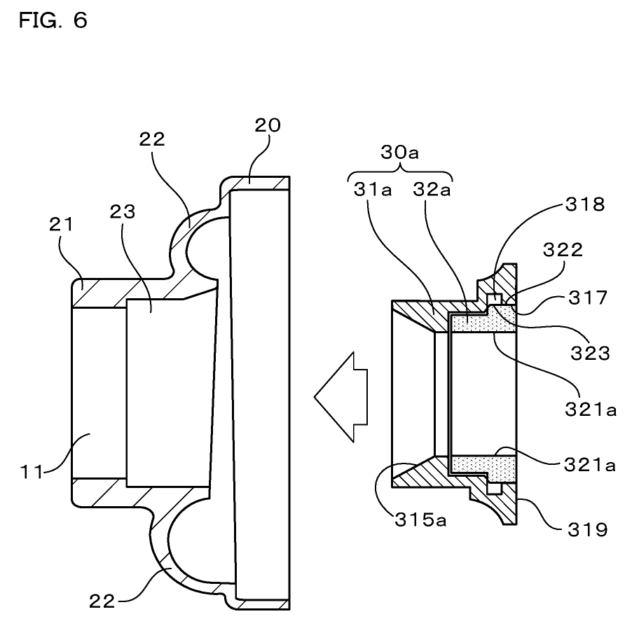

Next, the pre-formed abradable seal 32a is inserted into the pre-formed abradable seal fixing part 31a so as to place the cylindrical portion 324 of the pre-formed abradable seal 32a within the abradable seal disposition portion 316. Then, the press-fit abutting portion 322 is press-fitted in the press-fitting recessed portion 317. Consequently, a compressive stress directed radially inward from the press-fitting recessed portion 317 acts on the press-fit abutting portion 322. Under the compressive stress, the abradable seal 32 deforms radially inward. That is, the diameter of the press-fit abutting portion 322 of the abradable seal 32 (pre-formed abradable seal 32a) is reduced. Then, due to a reaction force against the compressive stress, a large frictional force is produced between the press-fitting recessed portion 317 and the press-fit abutting portion 322, whereby the abradable seal (pre-formed abradable seal 32a) is fixed to the abradable seal fixing part 31 (pre-formed abradable seal fixing part 31a). Consequently, as shown in FIG. 6, the pre-formed abradable seal fixing part 31a and the pre-formed abradable seal 32a are integrated to form a pre-formed shroud part 30a as one body.

As shown in FIG. 6, with the pre-formed abradable seal 32a press-fitted in the pre-formed abradable seal fixing part 31a, the bulging portion 323 of the pre-formed abradable seal 32a is opposed to the grooved portion 318. Consequently, a hollow space is formed between the pre-formed abradable seal fixing part 31a and the bulging portion 323, and thus the bulging portion 323 is configured to receive no compressive stress from the pre-formed abradable seal fixing part 31a after assembled. That is, whereas the diameter of the press-fit abutting portion 322 is reduced by compressive stress, the diameter of the bulging portion 323 that is not subjected to compressive stress after assembled, is not reduced. As a result, after assembled, the bulging portion 323 bulges radially outwardly (into the grooved portion 318) unlike the press-fit abutting portion 322.

Next, as shown in FIG. 6, the pre-formed shroud part 30a is press-fitted in the shroud part press-fitting portion 23 of the scroll unit 20 from the side opposite to the intake port 11 of the scroll unit 20. Subsequently, the inner circumferential surface 315a of the pre-formed abradable seal fixing part 31a and an inner circumferential surface 321a of the pre-formed abradable seal 32a are formed by cutting continuously. Consequently, as shown in FIG. 1, an inner circumferential surface 315b of the tubular press-fitting portion 315 of the abradable seal fixing part 31 and the shroud surface 321 of the abradable seal 32 are continuously formed with no substantial height difference.

Subsequently, the scroll unit 20 on which the shroud part 30 has been assembled is mounted on the back plate unit 50 rotatably supporting the impeller 10. Consequently, as shown in FIG. 1, the scroll chamber 12 is formed by the scroll chamber forming portion 22 of the scroll unit 20, the scroll chamber forming portion 313 of the abradable seal fixing part 31, and the scroll chamber forming portion 51 of the back plate unit 50, thereby completing the compressor housing 1.

Next, operational effects of the compressor housing 1 according to the present embodiment will be described in detail.

In the compressor housing 1 according to the present embodiment, the abradable seal 32 is press-fitted into the press-fitting recessed portion 317 of the abradable seal fixing part 31 in the axial direction X and the press-fit abutting portion 322 abuts against the inner circumferential surface of the press-fitting recessed portion 317 while the bulging portion 323 located at a forward side of the press-fit abutting portion 322 with respect to the press-fitting direction X is fixed to the abradable seal fixing part 31, opposing to the grooved portion 318 of the abradable seal fixing part 31. At an initial stage of assembly, the press-fit abutting portion 322 of the abradable seal 32 is press-fitted in the press-fitting recessed portion 317, and the diameter of the press-fit abutting portion 322 is reduced by compressive stress from the inner circumferential surface of the press-fitting recessed portion 317, thereby providing a sufficient interference between the abradable seal 32 and the inner circumferential surface of the press-fitting recessed portion 317 so that the abradable seal 32 is held by the abradable seal fixing part 31. Furthermore, since the bulging portion 323 of the abradable seal 32 has an outside diameter larger than the inside diameter of the press-fitting recessed portion 317 of the abradable seal fixing part 31, but smaller than the inside diameter of the grooved portion 318, the bulging portion 323 does not abut on the abradable seal fixing part 31. Therefore, a hollow space is formed in the radial direction between the bulging portion 323 and the inner wall surface of the grooved portion 318. Consequently, whereas the press-fit abutting portion 322 is subjected to compressive stress from the inner circumferential surface of the press-fitting recessed portion 317 in the abradable seal fixing part 31, the bulging portion 323 receives no compressive stress from the abradable seal fixing part 31 after assembled. And, in the press-fitting direction (axial direction X), the bulging portion 323 is located at a forward side of the press-fit abutting portion 322 that abuts on the inner circumferential surface of the press-fitting recessed portion 317 of the abradable seal fixing part 31. Thus, the bulging portion 323 is certainly caught by the grooved portion 318, to exert an anchoring effect. This enables to prevent movement in the axial direction X, of the abradable seal 32 that is press-fitted into the press-fitting recessed portion 317.

Furthermore, after assembled, the press-fit abutting portion 322, which continues to receive compressive stress from the inner circumferential surface of the press-fitting recessed portion 317, is deformed (plastic deformed) due to a creep phenomenon, but the bulging portion 323, which does not receive compressive stress from the abradable seal fixing part 31 after assembled, is not deformed due to a creep phenomenon. Consequently, even if the deformation of the press-fit abutting portion 322 due to a creep phenomenon, reduces the interference between the abradable seal 32 and the inner circumferential surface of the press-fitting recessed portion 317 to thereby reduce the holdability for the abradable seal 32 at the press-fit abutting portion 317, it is possible to secure and maintain the holdability for the abradable seal 32 by the anchoring effect of the bulging portion 323.

Furthermore, when the abradable seal 32 is press-fitted along the axial direction X during assembly, the bulging portion 323 located at a forward side of the press-fit abutting portion 322 with respect to the press-fitting direction is firstly press-fitted in the axial direction X before the press-fit abutting portion 322, with the diameter being reduced by compressive stress in the radial direction from the press-fitting recessed portion 317. Subsequently, when the abradable seal 32 is press-fitted further along the axial direction X, the press-fit abutting portion 322 abuts against the press-fitting recessed portion 317 and the diameter of the press-fit abutting portion 322 is reduced by compressive stress in the radial direction as described above while the bulging portion 323 reaches the grooved portion 318 and becomes free of compressive stress in the radial direction. The bulging portion 323 reduced in diameter by compressive stress at the initial stage of press-fitting tends to return to the original state by a restoring force upon reaching the grooved portion 318, accordingly. Consequently, the bulging portion 323 bulges out in the radial direction (direction perpendicular to the axial direction X) in the grooved portion 318, biting into the grooved portion 318. The entire bulging portion 323 in the axial direction X including the end portion 323a positioned forward with respect to the press-fitting direction X is located inside of the grooved portion 318 and is not restricted from bulging in the radial direction. This ensures a sufficient bulging amount d (bite amount into the grooved portion 318) of the bulging portion 323 in the grooved portion 318. As a result, the bulging portion 323 is certainly caught by the grooved portion 318, to exert a sufficient anchoring effect. This enables to prevent movement in the axial direction X, of the abradable seal 32 that is press-fitted into the press-fitting recessed portion 317.

Also, according to the present embodiment, the abradable seal 32 is fixed by press-fitting into the press-fitting recessed portion 317 of the abradable seal fixing part 31. This eliminates the need for parts for fixing the abradable seal 32 as conventionally required. This enables to fix the abradable seal 32 with a simple configuration without increasing parts count. As a result, production efficiency can be enhanced while curbing costs.

According to the present embodiment, before the abradable seal 32 (pre-formed abradable seal 32a) is press-fitted into the abradable seal fixing part 31 (pre-formed abradable seal fixing part 31a), the press-fit abutting portion 322 has the outside diameter that is equal to the outside diameter of the bulging portion 323, but larger than the inside diameter of the press-fitting recessed portion 317 of the pre-formed abradable seal fixing part 31a and smaller than the inside diameter of the grooved portion 318. This enables easy and reliable press-fitting of the press-fit abutting portion 322 of the abradable seal 32 into the press-fitting recessed portion 317 of the abradable seal fixing part 31, to allow the abradable seal 32 to be fixed securely to the abradable seal fixing part 31. In the present embodiment, although the press-fit abutting portion 322 has the outside diameter that is equal to the outside diameter of the bulging portion 323, the outside diameter of the press-fit abutting portion 322 can be determined appropriately by taking into consideration of the holdability for the abradable seal 32, assemblability, and the like.

According to the present embodiment, the bulging amount d of the bulging portion 323 on the basis of the press-fit abutting portion 322 is set at such a value as to produce an anchoring effect reliably. Consequently, even if the abradable seal 32 is subjected to an exciting force of the turbocharger, if the abradable seal 32 comes into contact with the impeller 10 and the blades 15 scrape the abradable seal 32, or if cutting is done to form the shroud surface 321, the abradable seal 32 can be held securely onto the abradable seal fixing part 31.

Also, according to the present embodiment, the wall surface 318a of the grooved portion 318, positioned forward with respect to the press-fitting direction X serves as the axial-direction restricting part 318a for restricting the press-fitting position of the abradable seal 32 in the axial direction X and the bulging portion 323 is formed between the press-fit abutting portion 322 and the axial-direction restricting part 318a. Consequently, the grooved portion 318 forms a hollow space between the bulging portion 323 and the abradable seal fixing part 31 such that the bulging portion 323 will not receive compressive stress from the abradable seal fixing part 31, and restricts the press-fitting position of the abradable seal 32. Therefore, it is not necessary to separately provide means for restricting the press-fitting position of the abradable seal 32, and a configuration of the shroud part 30 can be simplified.

Also, according to the present embodiment, the abradable seal 32 includes the cylindrical portion 324 at a forward side of the axial-direction restricting part 318a with respect to the press-fitting direction X. Consequently, the shroud surface 321 can be made sufficiently large.

According to the present embodiment, one grooved portion 318 is provided at the forward side of the press-fitting recessed portion 317 with respect to the press-fitting direction X and the abradable seal 32 has one bulging portion 323 at the forward side of the press-fit abutting portion 322 with respect to the press-fitting direction X. However, any press-fit abutting portion that is press-fitted into the abradable seal fixing part 31 with abutting thereon is not provided at the forward side of the bulging portion 323 with respect to the press-fitting direction X. If plural press-fit abutting portions and bulging portions are provided further at the forward side of the bulging portion 323 with respect to the press-fitting direction X, and plural press-fitting recessed portions 317 and grooved portions 318 are provided along the press-fitting direction X, when the abradable seal 32 is press-fitted, the bulging portion 323 having an outside diameter larger than the inside diameter of the press-fitting recessed portion 317 comes into contact with the plural press-fitting recessed portions 317 in sequence as being press-fitted. As a result, an outer circumferential portion of the bulging portion 323 is scraped, which may make it impossible for the bulging portion 323 to have a sufficient bulging amount d.

However, according to the present embodiment, as described above, only one grooved portion 318 is provided at the forward side of the press-fit abutting portion 322 with respect to the press-fitting direction X, and any press-fit abutting portion that is press-fitted into the abradable seal fixing part 31 with abutting thereon is not provided at the forward side of the bulging portion 323 with respect to the press-fitting direction X.

With such configuration, a situation in which the bulging portion 323 of the abradable seal 32 comes into contact with the plural grooved portions 318 in sequence does not occur. Thus, the outer circumferential portion of the bulging portion 323 is less liable to get scraped during press-fitting and a sufficient bulging amount d of the bulging portion 323 can be obtained.

Although in the present embodiment, before the abradable seal 32 (pre-formed abradable seal 32a) is press-fitted into the abradable seal fixing part 31 (pre-formed abradable seal fixing part 31a), the press-fit abutting portion 322 has the outside diameter that is equal to the outside diameter of the bulging portion 323, a tip portion of the bulging portion 323 on the forward side with respect to the press-fitting direction X may be reduced slightly in diameter by taking working efficiency during press-fitting into consideration.

Also, the outside diameter of the bulging portion 323 can be determined by taking into consideration of assemblability of the abradable seal 32, holdability, and the like. For example, to certainly locate the bulging portion 323 inside of the grooved portion 318, the outside diameter of the bulging portion 323 before press-fitting may be set slightly larger than that of the press-fit abutting portion 322 in advance as long as it does not obstruct the press-fitting.

Although in the present embodiment, the compressor housing 1 is configured to be divided into the scroll unit 20, the shroud part 30, and the back plate unit 50, this is not restrictive. A compressor housing integrally provided with a scroll unit and a shroud part may be combined with a back plate. The compressor housing 1 can be produced by a typical metal mold casting process as well as a die cast process. That is, for producing the compressor housing 1, how to divide and produce the compressor housing 1 is not particularly limited, and can be selected as desired.

Also, materials for forming the scroll unit 20 and abradable seal fixing part 31 are not particularly limited. Aluminum, iron, plastic, or the like can be adopted.

Thus, the present embodiment provides the compressor housing 1 which enables to sufficiently and reliably fix the abradable seal 32 and maintain holdability for the abradable seal 32 with a simple configuration.

### Embodiment 2

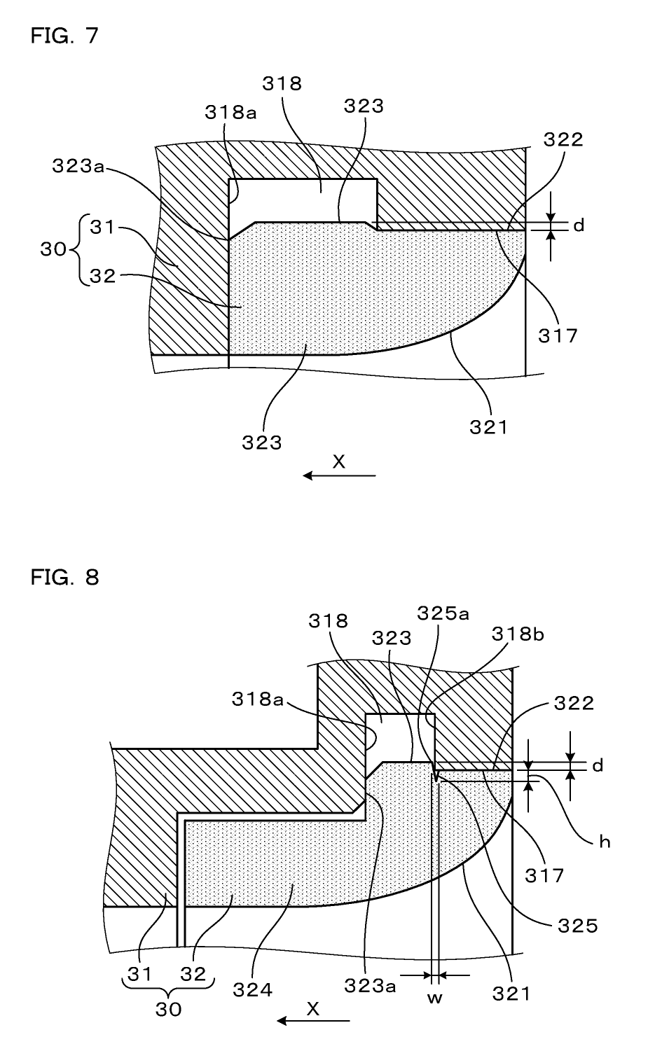

In the compressor housing 1 according to the present embodiment, as shown in FIG. 7, the abradable seal 32 does not have the cylindrical portion 324 (FIG. 4), and the end portion 323a of the abradable seal 32, positioned forward with respect to the press-fitting direction X abuts against the front-side wall surface 318a of the grooved portion 318 of the abradable seal fixing part 31, positioned forward in the press-fitting direction X. Consequently, the position of the abradable seal 32 in the axial direction X is determined at the end portion 323a positioned forward with respect to the press-fitting direction X. Note that components equivalent to those of Embodiment 1 are denoted by the same reference numerals as the corresponding components, and description thereof will be omitted.

The present embodiment also achieves operational effects equivalent to those of Embodiment 1 except for the operational effects attributable to the cylindrical portion 324 provided at a forward side of the front-side wall surface (axial-direction restricting part) 318a of the grooved portion 318 with respect to the press-fitting direction X.

### Embodiment 3

In the compressor housing 1 according to the present embodiment, as shown in FIG. 8, the abradable seal 32 has a cut portion 325 formed at a rear end portion of the bulging portion 323, positioned rearward with respect to the press-fitting direction X, (i.e., in a boundary portion between the bulging portion 323 and the press-fit abutting portion 322). As shown in FIG. 8, the cut portion 325 is formed in the circumferential direction along a rear-side wall surface 318b of the grooved portion 318, positioned rearward with respect to the press-fitting direction X. A sectional shape in the axial direction X, of the cut portion 325 is a V-shaped groove and is formed uniformly throughout the circumference. Besides the V-shape, the sectional shape of the cut portion 325 may be a U-shape, rectangular shape, arc shape, or the like. Note that components equivalent to those of Embodiment 1 are denoted by the same reference numerals as the corresponding components, and description thereof will be omitted.

Depth h of the cut portion 325 (a distance from a surface of the press-fit abutting portion 322 to the deepest part of the cut portion 325 in the radial direction) and width w of the cut portion 325 (a length in the axial direction X at an opening of the cut portion 325) can each be determined appropriately by taking into consideration of the material of the abradable seal 32, machining accuracy, operating environment, and sizes of the abradable seal 32 and press-fitting recessed portion 317.

Next, operational effects of the compressor housing 1 according to the present embodiment will be described in detail.

The press-fit abutting portion 322 of the abradable seal 32 is reduced in diameter by compressive stress from the press-fitting recessed portion 317 of the abradable seal fixing part 31 and press-fitted in the press-fitting recessed portion 317. In Embodiment 1, when the diameter of the press-fit abutting portion 322 is reduced, the rear end portion of the bulging portion 323 with respect to the press-fitting direction X, which is adjacent to the press-fit abutting portion 322, is pulled by the press-fit abutting portion 322, the diameter of which is reducing. As a result, the rear end portion of the bulging portion 323 with respect to the press-fitting direction X, even though not abutting on the inner circumferential surface of the press-fitting recessed portion 317, deforms with a smaller amount of change than the press-fit abutting portion 322, following the press-fit abutting portion 322. On the other hand, according to the present embodiment, since the cut portion 325 is formed at the rear end portion of the bulging portion 323 with respect to the press-fitting direction X, even if the diameter of the press-fit abutting portion 322 is reduced, the rear end portion of the bulging portion 323 with respect to the press-fitting direction X is prevented from deforming following the diameter reduction of the press-fit abutting portion 322. Consequently, because in a boundary portion 325a between the bulging portion 323 and the cut portion 325, the bulging amount d on the basis of the press-fit abutting portion 322 is maintained, allowing the bulging portion 323 to exhibit the anchoring effect sufficiently.

Also, according to the present embodiment, the cut portion 325 is formed in the circumferential direction along the rear-side wall surface 318b of the grooved portion 318, positioned rearward with respect to the press-fitting direction X. Consequently, the boundary portion 325a between the bulging portion 323 and the cut portion 325 is formed in the circumferential direction along the rear-side wall surface 318b of the grooved portion 318, positioned rearward with respect to the press-fitting direction X, and thus allowing the boundary portion 325a to exhibit sufficiently the anchoring effect for the rear-side wall surface 318b of the grooved portion 318, positioned rearward with respect to the press-fitting direction X.

Furthermore, according to the present embodiment, the cut portion 325 is formed throughout the circumference between the bulging portion 323 and the press-fit abutting portion 322. Consequently, the anchoring effect of the bulging portion 323 is sufficiently exhibited throughout the circumference.

According to the present embodiment, because the depth h of the cut portion 325 is equal to or larger than the bulging amount d of the bulging portion 323 (i.e., an amount of diameter reduction of the press-fit abutting portion 322), the amount of diameter reduction of the press-fit abutting portion 322 caused by press-fitting can be absorbed completely. This makes it possible to further prevent the bulging portion 323 from following the diameter reduction of the press-fit abutting portion 322.

The present embodiment also achieves operational effects equivalent to those of Embodiment 1.

### Embodiment 4

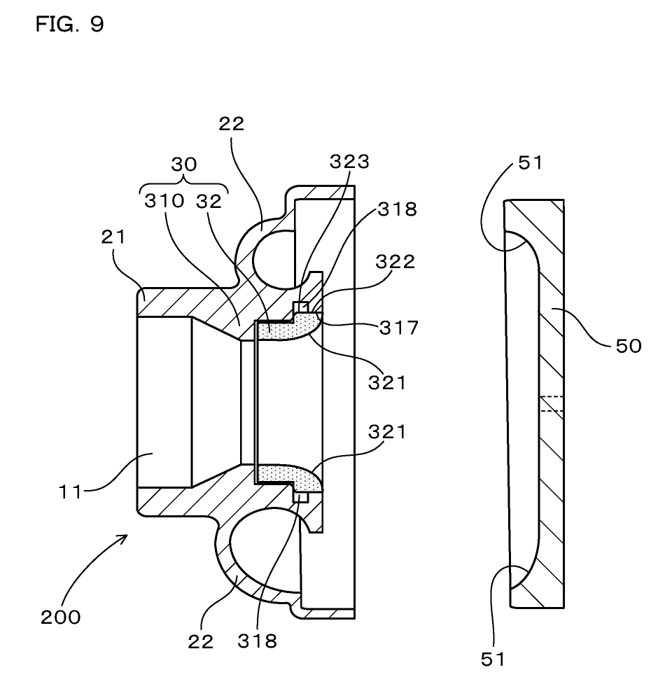

The compressor housing 1 according to the present embodiment, includes an abradable seal fixing part 310 formed integrally with a scroll unit 200 equipped with a scroll chamber forming portion 22 as shown in FIG. 9, in place of the abradable seal fixing part 31 according to Embodiment 1 (see FIG. 1). The abradable seal fixing part 310 has a shape equivalent to that of the abradable seal fixing part 31 (see FIG. 1) except that the abradable seal fixing part 310 is formed integrally with the scroll unit 200. Note that components equivalent to those of Embodiment 1 are denoted by the same reference numerals as the corresponding components, and description thereof will be omitted.

With the compressor housing 1 according to the present embodiment, since the abradable seal fixing part 310 is formed integrally with the scroll unit 200, parts count in the whole of an apparatus can be slashed compared to when the abradable seal fixing part 310 and scroll unit 200 are provided as separate components. The present embodiment also achieves operational effects equivalent to those of Embodiment 1.

### Embodiment 5

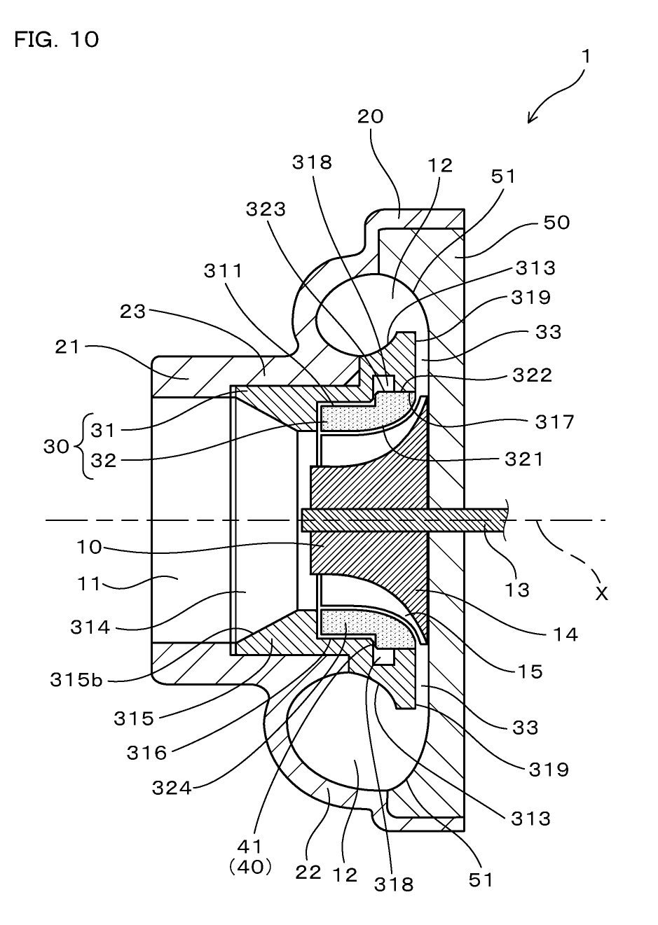

A compressor housing for a turbocharger according to the present embodiment will be described with reference to FIGS. 10 to 13. Components equivalent to those of Embodiments 1 to 4 are denoted by the same reference numerals as the corresponding components, and description thereof will be omitted.

With the compressor housing 1 according to the present embodiment, as shown in FIG. 10, before the abradable seal 32 is press-fitted, the outside diameter of the bulging portion 323 is equal to the inside diameter of the press-fitting recessed portion 317 of the abradable seal fixing part 31, and after the abradable seal 32 is press-fitted, the bulging portion 323 bulges more outwardly than the press-fit abutting portion 322 in the radial direction.

A movement restriction member 40 is interposed between the abradable seal 32 and the abradable seal fixing part 31 to restrict the abradable seal 32 from moving in the axial direction X.

The compressor housing 1 according to the present embodiment will be described in detail below.

As shown in FIG. 10, the opposite side to the suction passage 314 in the tubular press-fitting portion 315 corresponds to the right side of FIG. 10, i.e., a downstream side of airflow.

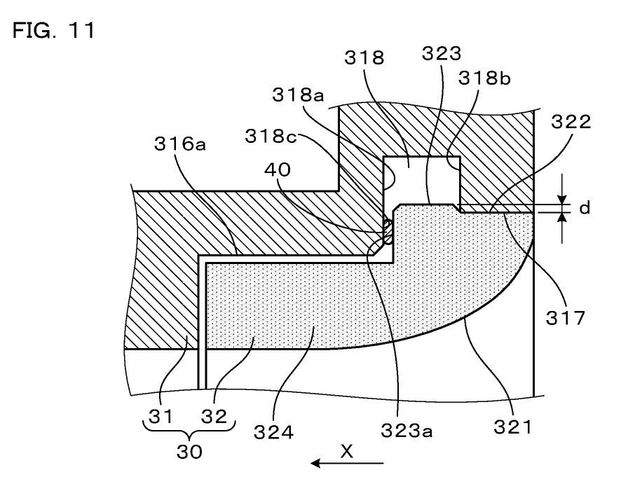

The bulging amount d in FIG. 11 can be determined based on a required fall-off load calculated, taking into account of vibration of the turbocharger and mass of the abradable seal. To satisfy the bulging amount d, press-fit sizes and machining tolerances can be determined in consideration of various materials and the operating environment. For example, the press-fit sizes and tolerances can be determined such that the bulging amount d satisfy the required fall-off load by taking into consideration of recovery from swelling of the abradable seal 32, permanent growth of aluminum that is a material for forming the abradable seal fixing part 31, a difference in linear thermal expansion between the abradable seal 32 and the abradable seal fixing part 31, dimensional changes of the abradable seal fixing part 31 and the abradable seal 32 due to differences between temperatures inside and outside the compressor housing 1 under operation of the turbocharger, assemble workability of the abradable seal 32 onto the abradable seal fixing part 31, and the like.

As shown in FIG. 11, the abradable seal fixing part 31 includes a press-fitting direction opposing surface 318c opposed to a forward face 323a of the abradable seal 32 with respect to the press-fitting direction. The press-fitting direction opposing surface 318c is flush with the front-side wall surface 318a of the grooved portion 318 positioned with respect to the press-fitting direction.

The movement restriction member 40 is interposed between the press-fitting direction opposing surface 318c and the forward face 323a. According to the present embodiment, the movement restriction member 40 is made up of an O-ring 41 serving as a biasing member for biasing the abradable seal 32 rearward in the press-fitting direction. The O-ring 41 is made of a material having a Young's modulus (longitudinal elastic modulus) lower than that of the material for forming the abradable seal 32 and is more elastically deformable than the abradable seal 32.

The O-ring 41 is compressed in the axial direction X by the forward face 323a of the abradable seal 32 that is press-fitted into the press-fitting recessed portion 317 and the press-fitting direction opposing surface 318c of the abradable seal fixing part 31, and is kept deformed under the compression. Consequently, the abradable seal 32 is biased rearward in the press-fitting direction by a reaction force of the elastically deformed O-ring 41 to the compressive stress with the press-fit position of the abradable seal 32 being restricted in the press-fitting direction (axial direction X).

Next, a method for assembling the compressor housing 1 according to the present embodiment will be described.

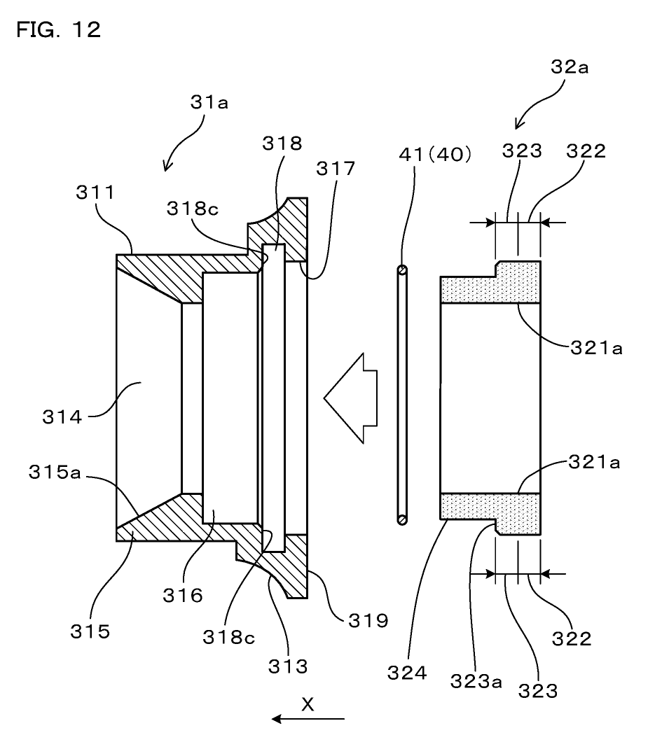

In assembling the compressor housing 1 according to the present embodiment, as shown in FIG. 12, the pre-formed abradable seal 32a and pre-formed abradable seal fixing part 31a are prepared first in the same manner as in Embodiment 1.

Next, the O-ring 41 is fitted on the cylindrical portion 324 of the pre-formed abradable seal 32a along a forward face 323a of the pre-formed abradable seal 32a, positioned forward with respect to the press-fitting direction, which is an end face of the pre-formed abradable seal 32a, positioned forward with respect to the press-fitting direction. Then, the pre-formed abradable seal 32a is inserted into the pre-formed abradable seal fixing part 31a so as to place the cylindrical portion 324 of the pre-formed abradable seal 32a inside of the abradable seal disposition portion 316. Then, the press-fit abutting portion 322 is press-fitted into the press-fitting recessed portion 317 until the O-ring 41 mounted on the pre-formed abradable seal 32a abuts on the press-fitting direction opposing surface 318c of the pre-formed abradable seal fixing part 31a and is compressed in the press-fitting direction by the forward face 323a and the press-fitting direction opposing surface 318c so that the abradable seal can avoid influence of vibration even if reduction in compression allowance due to high-temperature creep is factored in.

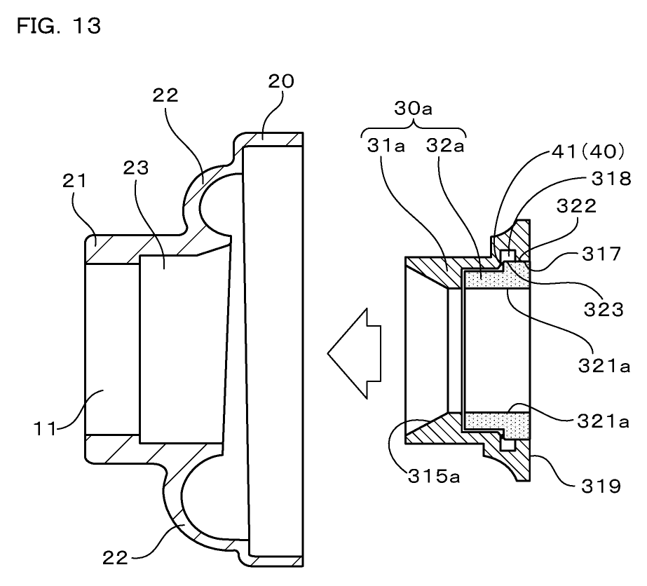

Consequently, as with Embodiment 1, the abradable seal (pre-formed abradable seal 32a) is fixed to the abradable seal fixing part 31 (pre-formed abradable seal fixing part 31a) and the pre-formed shroud part 30a is formed as one body integrating the pre-formed abradable seal fixing part 31a and pre-formed abradable seal 32a as shown in FIG. 13.

Furthermore, the O-ring 41 compressed in the press-fitting direction by the forward face 323a and the press-fitting direction opposing surface 318c generates a reaction force to the compressive stress. The abradable seal 32 (pre-formed abradable seal 32a) is biased rearward in the press-fitting direction by the reaction force.

As shown in FIG. 11, as with Embodiment 1, the bulging portion 323 bulges radially outwardly (into the grooved portion 318) unlike the press-fit abutting portion 322 after assembly.

Next, as shown in FIG. 13, as with Embodiment 1, the pre-formed shroud part 30a is press-fitted in the shroud part press-fitting portion 23 and the inner circumferential surface 315a and the inner circumferential surface 321a are continuously cut to form a continuous surface with no substantial height difference between the inner circumferential surface 315b of the tubular press-fitting portion 315 and the shroud surface 321 of the abradable seal 32.

Subsequently, as with Embodiment 1, the scroll unit 20 on which the shroud part 30 has been assembled is mounted on the back plate unit 50 that rotatably supports the impeller 10 to complete the compressor housing 1 as shown in FIG. 10.

Next, operational effects of the compressor housing 1 according to the present embodiment will be described in detail.

In the compressor housing 1 according to the present embodiment, the abradable seal 32 is provided by press-fitting into the abradable seal fixing part 31. Therefore, no fastening member such as a screw member is used for fixing the abradable seal 32, then, a housing recess as conventionally provided to keep part of the fastening member from projecting into a fluid passage from the diffuser surface 319, needs not be provided. Consequently, a flow of air discharged from the impeller 10 is not disturbed on the diffuser surface 319. This prevents reduction in compression efficiency. Also, because it is not necessary to fill the housing recess with putty or the like as conventionally done, the number of manufacturing processes can be reduced, which is advantageous in terms of cost as well. In addition, since it is not necessary to prepare a region for fixing a fastening member to the abradable seal 32, the abradable seal 32 can be downsized, which is advantageous in term of cost.

In the compressor housing 1 according to the present embodiment, the abradable seal 32 is press-fitted into the press-fitting recessed portion 317 of the abradable seal fixing part 31 in the axial direction X and the press-fit abutting portion 322 abuts against the inner circumferential surface of the press-fitting recessed portion 317 while the bulging portion 323 located at a forward side of the press-fit abutting portion 322 with respect to the press-fitting direction is fixed to the abradable seal fixing part 31, opposing to the grooved portion 318 of the abradable seal fixing part 31. At an initial stage of assembly, the press-fit abutting portion 322 of the abradable seal 32 is press-fitted in the press-fitting recessed portion 317, and the diameter of the press-fit abutting portion is reduced by compressive stress from the inner circumferential surface of the press-fitting recessed portion 317, thereby providing sufficient holdability between the abradable seal 32 and the inner circumferential surface of the press-fitting recessed portion 317, so that the abradable seal 32 is held by the abradable seal fixing part 31. Furthermore, since the bulging portion 323 of the abradable seal 32 has an outside diameter larger than the inside diameter of the press-fitting recessed portion 317 of the abradable seal fixing part 31, but smaller than the inside diameter of the grooved portion 318, the bulging portion 323 does not abut on the abradable seal fixing part 31. Therefore, a hollow space is formed in the radial direction between the bulging portion 323 and the inner wall surface of the grooved portion 318. Consequently, whereas the press-fit abutting portion 322 is subjected to compressive stress from the inner circumferential surface of the press-fitting recessed portion 317 of the abradable seal fixing part 31, the bulging portion 323 receives no compressive stress from the abradable seal fixing part 31 after assembled. And, in the press-fitting direction (axial direction X), the bulging portion 323 is located at a forward side of the press-fit abutting portion 322 that abuts on the inner circumferential surface of the press-fitting recessed portion 317 of the abradable seal fixing part 31. Thus, the bulging portion 323 is certainly caught by the grooved portion 318 to exert an anchoring effect. This enables to restrict movement in the axial direction X, of the abradable seal 32 that is press-fitted into the press-fitting recessed portion 317.

Furthermore, after assembled, the press-fit abutting portion 322 continuously receives compressive stress from the inner circumferential surface of the press-fitting recessed portion 317, so that the press-fit abutting portion develops deformation (plastic deformation) due to a creep phenomenon, whereas the bulging portion 323 receives no compressive stress from the abradable seal fixing part 31 after assembled, so that the bulging portion 323 develops no deformation due to a creep phenomenon. Consequently, even if the deformation of the press-fit abutting portion 322 due to a creep phenomenon reduces the interference between the abradable seal 32 and the inner circumferential surface of the press-fitting recessed portion 317 to thereby reduce the holdability for the abradable seal 32 at the press-fit abutting portion 322, it is possible to secure the holdability for the abradable seal 32 by the anchoring effect of the bulging portion. The holdability can be maintained for a long period.

Furthermore, when the abradable seal 32 is press-fitted along the axial direction X during assembly, the diameter of the bulging portion 323 located at a forward side of the press-fit abutting portion 322 with respect to the press-fitting direction is firstly press-fitted in the axial direction X before the press-fit abutting portion 322, with the diameter being reduced by compressive stress in the radial direction from the press-fitting recessed portion 317. Subsequently, when the abradable seal 32 is press-fitted further along the axial direction X, the press-fit abutting portion 322 abuts against the press-fitting recessed portion 317 and the diameter of the press-fit abutting portion 322 is reduced by compressive stress in the radial direction as described above while the bulging portion 323 reaches the grooved portion 318 and becomes free of compressive stress in the radial direction. The bulging portion 323 reduced in diameter by compressive stress at the initial stage of press-fitting tends to return to the original state by a restoring force upon reaching the grooved portion 318, accordingly. Consequently, the bulging portion 323 bulges out in the radial direction (direction perpendicular to the axial direction X) in the grooved portion 318, biting into the grooved portion 318 in appearance. The entire bulging portion 323 in the axial direction X including the forward face 323a, positioned forward with respect to the press-fitting direction X is located inside of the grooved portion 318 and is not restricted from bulging in the radial direction. This ensures a sufficient bulging amount d (bite amount into the grooved portion 318) of the bulging portion 323 in the grooved portion 318. As a result, the bulging portion 323 is certainly caught by the grooved portion 318, to exert a sufficient anchoring effect. This enables to prevent movement in the axial direction X, of the abradable seal 32 that is press-fitted into the press-fitting recessed portion 317.

Furthermore, the movement restriction member 40 is interposed between the abradable seal 32 and the abradable seal fixing part 31 to restrict the abradable seal 32 from moving in the axial direction X. When the press-fit abutting portion 322 is deformed due to a creep phenomenon, the interference between the abradable seal 32 and the inner circumferential surface of the press-fitting recessed portion 317 is reduced, thereby reducing the holdability for the abradable seal 32 at the press-fit abutting portion 322. According to the aforesaid configuration, since the movement restriction member 40 restricts the abradable seal 32 from moving in the axial direction X, the abradable seal 32 is prevented from wobbling in the axial direction X.

Also, according to the present embodiment, the abradable seal fixing part 31 includes the press-fitting direction opposing surface 318c that is opposed to a forward face 323a of the abradable seal 32, positioned forward with respect to the press-fitting direction. The movement restriction member 40 is made up of the O-ring 41 serving as a biasing member for biasing the abradable seal 32 rearward in the press-fitting direction, and is interposed between the press-fitting direction opposing surface 318c and the forward face 323a of the abradable seal 32 with respect to the press-fitting direction. Thus, since the abradable seal 32 is biased rearward in the press-fitting direction by the O-ring 41, so that the bulging portion 323 abuts reliably against a press-fitting direction rear end portion 318b of the grooved portion 318. As a result, the abradable seal 32 is restricted from moving in the axial direction X, and thus, the abradable seal 32 is prevented from wobbling in the axial direction X and restrained from wear.

Although in the present embodiment, the O-ring 41 is used as the biasing member making up the movement restriction member 40, a disc spring may be used alternatively. Also, in place of the O-ring 41 as the biasing member, plural resin-made members may be interposed between the press-fitting direction opposing surface 318c and the forward face 323a for use as the biasing member.

According to the present embodiment, before the abradable seal 32 (pre-formed abradable seal 32a) is press-fitted into the abradable seal fixing part 31 (pre-formed abradable seal fixing part 31a), the press-fit abutting portion 322 has an outside diameter that is equal to the outside diameter of the bulging portion 323, but larger than the inside diameter of the press-fitting recessed portion 317 of the pre-formed abradable seal fixing part 31a and smaller than the inside diameter of the grooved portion 318. This enables easy and reliable press-fitting of the press-fit abutting portion 322 of the abradable seal 32 into the press-fitting recessed portion 317 of the abradable seal fixing part 31, to allow the abradable seal 32 to be fixed securely to the abradable seal fixing part 31. In the present embodiment, although the outside diameter of the press-fit abutting portion 322 is equal to the outside diameter of the bulging portion 323, the outside diameter of the press-fit abutting portion 322 can be determined appropriately by taking into consideration of the holdability for the abradable seal 32, assemblability, and the like.

According to the present embodiment, the bulging amount d of the bulging portion 323 on the basis of the press-fit abutting portion 322 is set at such a value as to produce an anchoring effect reliably. Consequently, even if the abradable seal 32 is subjected to an exciting force of the turbocharger, if the abradable seal 32 comes into contact with the impeller 10 and the blades 15 scrape the abradable seal 32, or if cutting is done to form the shroud surface 321, the abradable seal 32 can be held securely onto the abradable seal fixing part 31.

Also, according to the present embodiment, the press-fitting direction opposing surface 318c formed to be flush with the wall surface 318a of the grooved portion 318, positioned forward with respect to the press-fitting direction restricts the press-fitting position of the abradable seal 32 in the axial direction X. Consequently, the grooved portion 318 forms a hollow space between the bulging portion 323 and the abradable seal fixing part 31 such that the bulging portion 323 will not receive compressive stress from the abradable seal fixing part 31 and restricts the press-fitting position of the abradable seal 32. Therefore, it is not necessary to separately provide means for restricting the press-fitting position of the abradable seal 32, and a configuration of the shroud part 30 can be simplified.

Also, according to the present embodiment, the abradable seal 32 includes the cylindrical portion 324 at a forward side of the press-fitting direction opposing surface 318c with respect to the press-fitting direction. Consequently, the shroud surface 321 can be made sufficiently large.

According to the present embodiment, one grooved portion 318 is provided at the forward side of the press-fitting recessed portion 317 with respect to the press-fitting direction and the abradable seal 32 has one bulging portion 323 at the forward side of the press-fit abutting portion 322 with respect to the press-fitting direction. Thus, any portion abutting against each other, such as the press-fitting recessed portion 317 and press-fit abutting portion 322, is not provided at the forward side of the bulging portion 323 with respect to the press-fitting direction.

If plural press-fit abutting portions and bulging portions are provided further at the forward side of the bulging portion 323 with respect to the press-fitting direction, and plural press-fitting recessed portions 317 and grooved portions 318 are provided along the press-fitting direction, when the abradable seal 32 is press-fitted, the bulging portion 323 having an outside diameter larger than the inside diameter of the press-fitting recessed portion 317 comes into contact with the plural press-fitting recessed portions 317 in sequence as being press-fitted. As a result, an outer circumferential portion of the bulging portion 323 is scraped, which may make it impossible for the bulging portion 323 to have a sufficient bulging amount d of.

However, according to the present embodiment, as described above, only one grooved portion 318 is provided at the forward side of the press-fit abutting portion 322 with respect to the press-fitting direction, and any portion abutting against each other, such as the press-fitting recessed portion 317 and press-fit abutting portion 322, is not provided at the forward side of the bulging portion 323 with respect to the press-fitting direction. With such configuration, a situation in which the bulging portion 323 of the abradable seal 32 comes into contact with the plural grooved portions 318 in sequence does not occur. Thus, the outer circumferential portion of the bulging portion 323 is less liable to get scraped during press-fitting and a sufficient bulging amount d of the bulging portion 323 can be obtained.

Although in the present embodiment, before the abradable seal 32 (pre-formed abradable seal 32a) is press-fitted into the abradable seal fixing part 31 (pre-formed abradable seal fixing part 31a), the press-fit abutting portion 322 has the outside diameter that is equal to the outside diameter of the bulging portion 323, a tip portion of the bulging portion 323 at the forward side with respect to the press-fitting direction may be reduced slightly in diameter in consideration of working efficiency during press-fitting.

Also, the outside diameter of the bulging portion 323 can be determined by taking into consideration of assemblability of the abradable seal 32, holdability, and the like. For example, to certainly locate the bulging portion 323 inside of the grooved portion 318, the outside diameter of the bulging portion 323 before press-fitting may be set slightly larger than that of the press-fit abutting portion 322 in advance as long as it does not obstruct the press-fitting.

Although in the present embodiment, the compressor housing 1 is configured to be divided into the scroll unit 20, the shroud part 30, and the back plate unit 50, this is not restrictive. A compressor housing integrally provided with a scroll unit and a shroud part may be combined with a back plate. The compressor housing 1 can be produced by a typical metal mold casting process as well as a die-casting process. That is, for producing the compressor housing 1, how to divide and produce the compressor housing 1 is not particularly limited, and can be selected as desired.

Also, materials for forming the scroll unit 20 and abradable seal fixing part 31 are not particularly limited. Aluminum, iron, plastic, or the like can be adopted.

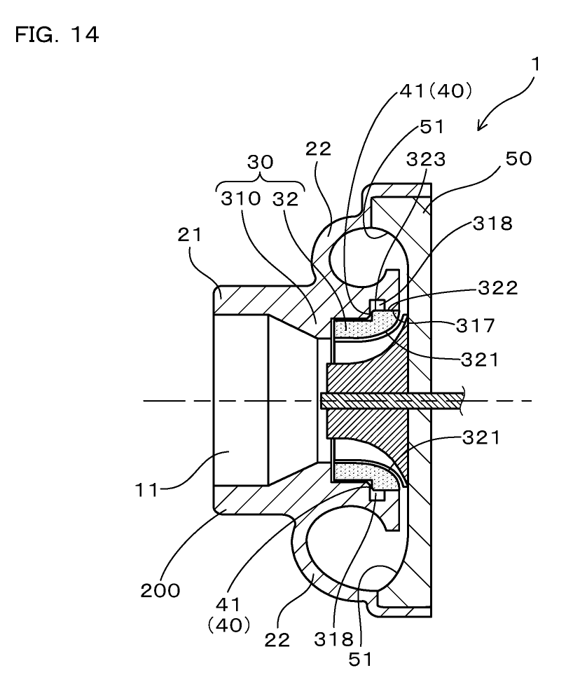

The compressor housing 1 according to the present embodiment, may include the abradable seal fixing part 310 formed integrally with the scroll unit 200 having the scroll chamber forming portion 22 as shown in FIG. 14, in place of the abradable seal fixing part 31 (see FIG. 10) according to Embodiment 5. The abradable seal fixing part 310 has a shape equivalent to that of the abradable seal fixing part 31 (see FIG. 10) except that the abradable seal fixing part 310 is formed integrally with the scroll unit 200. With such a variation, since the abradable seal fixing part 310 is formed integrally with the scroll unit 200, parts count in the whole of an apparatus can be reduced compared to when the abradable seal fixing part 310 and scroll unit 200 are provided as separate components.

Thus, the present embodiment provides the compressor housing 1 that enables to prevent wobbling of the abradable seal 32 to thereby restrain wear of the abradable seal 32 while preventing reduction in compression efficiency.

### Embodiment 6

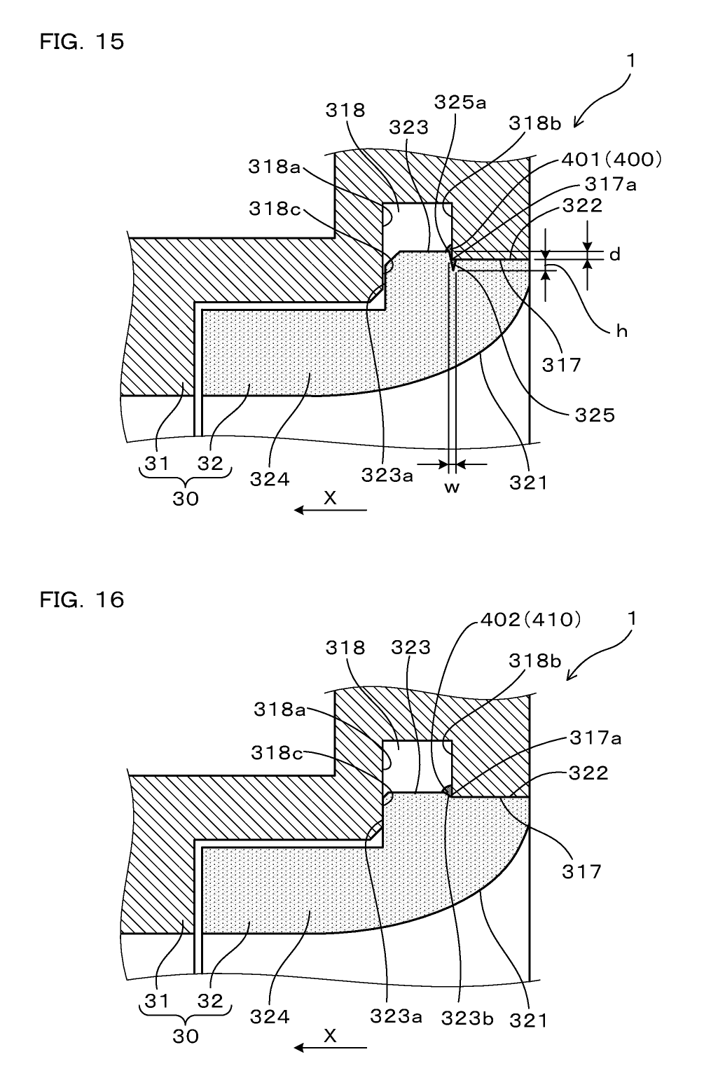

The compressor housing 1 according to the present embodiment includes a movement restriction member 400 shown in FIG. 15 in place of the movement restriction member 40 according to Embodiment 5 (see FIGS. 10 and 11), which is made up of the O-ring 41 serving as the biasing member. Components equivalent to those of Embodiments 1 to 5 are denoted by the same reference numerals as the corresponding components, and description thereof will be omitted.

According to the present embodiment, as shown in FIG. 15, a cut portion 325 cut radially inwardly is formed in the abradable seal 32 along a corner 317a of the abradable seal fixing part 31. A sectional shape in the axial direction X, of the cut portion 325 is a V-shaped groove and the cut portion 325 is formed uniformly throughout the circumference.

Besides the V-shape, the sectional shape of the cut portion 325 may be a U-shape, rectangular shape, arc shape, or the like.

Depth h of the cut portion 325 (a distance from a surface of the press-fit abutting portion 322 to the deepest part of the cut portion 325 in the radial direction) and width w of the cut portion 325 (a length in the axial direction X at an opening of the cut portion 325) can each be determined appropriately by taking into consideration of the material of the abradable seal 32, machining accuracy, operating environment, and sizes of the abradable seal 32 and press-fitting recessed portion 317.

An adhesive is applied to the cut portion 325. Consequently, a bonding layer 401 for joining the corner 317a and the abradable seal 32 is formed along the corner 317a between the grooved portion 318 and the press-fitting recessed portion 317 of the abradable seal fixing part 31. The bonding layer 401 joins together the abradable seal fixing part 31 and abradable seal 32, forming the movement restriction member 400 for restricting the abradable seal 32 from moving in the axial direction X. Material of the adhesive forming the bonding layer 401 is not particularly limited, but an acrylic resin adhesive, polyurethane resin adhesive, epoxy resin adhesive, vinyl chloride resin adhesive, and the like are available for use.

Next, operational effects of the compressor housing 1 according to the present embodiment will be described in detail.

The press-fit abutting portion 322 of the abradable seal 32 is reduced in diameter by compressive stress from the press-fitting recessed portion 317 of the abradable seal fixing part 31 and press-fitted in the press-fitting recessed portion 317. In Embodiment 5, when the diameter of the press-fit abutting portion 322 is reduced, the rear end portion of the bulging portion 323, positioned rearward with respect to the press-fitting direction, which is adjacent to the press-fit abutting portion 322, is pulled by the press-fit abutting portion 322, the diameter of which is reducing. As a result, the press-fitting direction rear end portion of the bulging portion 323, even though not abutting on the inner circumferential surface of the press-fitting recessed portion 317, deforms with a smaller amount of change than the press-fit abutting portion 322, following the press-fit abutting portion 322. On the other hand, according to the present embodiment, since the cut portion 325 is formed at the boundary portion between the bulging portion 323 and the press-fit abutting portion 322, even if the diameter of the press-fit abutting portion 322 is reduced, the press-fitting direction rear end portion of the bulging portion 323 with respect to the press-fitting direction is prevented from deforming following the diameter reduction of the press-fit abutting portion 322. Consequently, because in a boundary portion 325a between the bulging portion 323 and the cut portion 325, the bulging amount d on the basis of the press-fit abutting portion 322 is maintained, allowing the bulging portion 323 to exhibit the anchoring effect sufficiently.

Furthermore, the cut portion 325 is formed in the circumferential direction along the corner 317a of the abradable seal fixing part 31. Consequently, the boundary portion 325a between the bulging portion 323 and the cut portion 325 is formed in the circumferential direction along the corner 317a of the abradable seal fixing part 31. As a result, the boundary portion 325a exhibits sufficiently the anchoring effect for the rear-side wall surface 318b of the grooved portion 318, positioned rearward with respect to the press-fitting direction.

Furthermore, according to the present embodiment, the cut portion 325 is formed throughout the circumference between the bulging portion 323 and the press-fit abutting portion 322. Consequently, the anchoring effect of the bulging portion 323 is exhibited throughout the circumference.

According to the present embodiment, because the depth h of the cut portion 325 is equal to or larger than the bulging amount d of the bulging portion 323 (i.e., an amount of diameter reduction of the press-fit abutting portion 322), the amount of diameter reduction of the press-fit abutting portion 322 caused by press-fitting can be absorbed completely. This makes it possible to further prevent the bulging portion 323 from being reduced in diameter by following the diameter reduction of the press-fit abutting portion 322.

Also, the bonding layer 401 is made up of an adhesive applied to the cut portion 325 formed between the bulging portion 323 and the press-fit abutting portion 322 by cutting the abradable seal 32 radially inwardly. Consequently, the adhesive is held in the cut portion 325, forming the bonding layer 401 reliably. As a result, the corner 317a of the abradable seal fixing part 31 is bonded to the outer circumference of the abradable seal 32 reliably via the bonding layer 401. Thus, the abradable seal 32 can be prevented from wobbling in the axial direction X and restrained from wear.

Although in the present embodiment, the cut portion 325 is formed all around the circumference of the abradable seal 32 and an adhesive is applied to the cut portion 325 to form the bonding layer 401, this is not restrictive. A cut portion may be formed in only part of the circumference of the abradable seal 32 and an adhesive may be applied to the cut portion to form the bonding layer 401. Alternatively, the bonding layer 401 may be formed by applying an adhesive to the boundary portion between the bulging portion 323 of the abradable seal 32 and the press-fit abutting portion 322 of the abradable seal 32 in advance without forming the cut portion 325. Alternatively, the bonding layer 401 may be formed by applying an adhesive to the corner 317a of the abradable seal fixing part 31 in advance.

The present embodiment also achieves operational effects equivalent to those of Embodiment 5. Also, the compressor housing 1 may include the movement restriction member 40 according to Embodiment 5, made up of the O-ring 41 in addition to the movement restriction portion 400 according to the present embodiment, made up of the bonding layer 401.

### Embodiment 7

The compressor housing 1 according to the present embodiment includes a movement restriction member 410 shown in FIG. 16 in place of the movement restriction member 40 according to Embodiment 5 (see FIGS. 10 and 11), which is made up of the O-ring 41 serving as the biasing member. Components equivalent to those of Embodiment 5 are denoted by the same reference numerals as the corresponding components, and description thereof will be omitted.

According to the present embodiment, the abradable seal 32 has no cut portion 325 (see FIG. 15) formed therein. Before the abradable seal 32 is press-fitted, an adhesive is applied to the corner 317a of the abradable seal fixing part 31 to form a bonding layer 402 in advance. When the abradable seal 32 is press-fitted, a press-fitting direction rear end portion 323b of the bulging portion 323 is bonded to the corner 317a via the bonding layer 402. The bonding layer 402 forms the movement restriction member 410 for restricting the abradable seal 32 from moving in the axial direction X. Material of the adhesive forming the bonding layer 402 can be the same as the bonding layer 401 described above.

The compressor housing 1 according to the present embodiment achieves operational effects similar to those of Embodiment 6 except for the effect attributable to the cut portion 325. Also, with the present embodiment, since there is no need to form the cut portion 325, the abradable seal 32 can be formed easily.

1-10. (canceled)

11. A compressor housing for a turbocharger configured to house an impeller, the compressor housing comprising:
an intake port for sucking air toward the impeller;
a scroll chamber for introducing air discharged by the impeller thereinto, the scroll chamber being formed in a circumferential direction at an outer circumferential side of the impeller; and
a shroud part having a shroud surface opposed to the impeller; wherein
the shroud part includes an annular abradable seal, an inner circumferential surface of which serves as the shroud surface, and an annular abradable seal fixing part to which the abradable seal is fixed,
the abradable seal fixing part includes a press-fitting recessed portion into which the abradable seal is press-fitted, and a grooved portion recessively formed radially outwardly in the circumferential direction at a forward side of the press-fitting recessed portion with respect to a press-fitting direction of the abradable seal, and
the abradable seal includes a press-fit abutting portion that is press-fitted into the press-fitting recessed portion in an axial direction and abuts against an inner circumferential surface of the press-fitting recessed portion, and a bulging portion provided in a manner opposing to the grooved portion at a forward side of the press-fit abutting portion with respect to the press-fitting direction, the bulging portion having an outside diameter that is larger than an inside diameter of the press-fitting recessed portion of the abradable seal fixing part, but smaller than an inside diameter of the grooved portion.

12. The compressor housing according to claim 11, wherein the press-fit abutting portion of the abradable seal has an outside diameter that is equal to an outside diameter of the bulging portion before being press-fitted into the abradable seal fixing part and is smaller than the outside diameter of the bulging portion after being press-fitted into the abradable seal fixing part.

13. The compressor housing according to claim 11, wherein the abradable seal has a cut portion cut radially inwardly, the cut portion being formed between the bulging portion and the press-fit abutting portion.

14. The compressor housing according to claim 11, wherein the cut portion is formed in a circumferential direction along a rear-side wall surface of the grooved portion with respect to the press-fitting direction.

15. The compressor housing according to claim 11, wherein the compressor housing further comprises an axial-direction restricting part for restricting a press-fitting position of the abradable seal in the axial direction by abutment of the abradable seal against a front-side wall surface of the grooved portion with respect to the press-fitting direction, and the bulging portion is formed between the press-fit abutting portion and the axial-direction restricting part.

16. The compressor housing according to claim 11, further comprising a movement restriction member for restricting a movement of the abradable seal in the axial direction, the movement restriction member being interposed between the abradable seal and the abradable seal fixing part.

17. The compressor housing according to claim 16, wherein the abradable seal fixing part includes a press-fitting direction opposing surface that is opposed to a forward face of the abradable seal with respect to the press-fitting direction, and the movement restriction member is made up of a biasing member for biasing the abradable seal rearward in the press-fitting direction, the biasing member being interposed between the press-fitting direction opposing surface and the forward face of the abradable seal.

18. The compressor housing according to claim 16, wherein the movement restriction member is formed on an outer circumference of the abradable seal along a corner of the abradable seal fixing part between the grooved portion and the press-fitting recessed portion, and is made up of a bonding layer that bonds together the corner of the abradable seal fixing part and the outer circumference of the abradable seal.

19. The compressor housing according to claim 18, wherein the bonding layer is made up of an adhesive applied to a cut portion formed between the bulging portion and the press-fit abutting portion by cutting the abradable seal radially inwardly.

20. The compressor housing according to claim 19, wherein the cut portion is formed in the circumferential direction along the corner of the abradable seal fixing part.

21. The compressor housing according to claim 12, wherein the abradable seal has a cut portion cut radially inwardly, the cut portion being formed between the bulging portion and the press-fit abutting portion.

22. The compressor housing according to claim 21, wherein the cut portion is formed in a circumferential direction along a rear-side wall surface of the grooved portion with respect to the press-fitting direction.

23. The compressor housing according to claim 22, wherein the compressor housing further comprises an axial-direction restricting part for restricting a press-fitting position of the abradable seal in the axial direction by abutment of the abradable seal against a front-side wall surface of the grooved portion with respect to the press-fitting direction, and the bulging portion is formed between the press-fit abutting portion and the axial-direction restricting part.

24. The compressor housing according to claim 23, further comprising a movement restriction member for restricting a movement of the abradable seal in the axial direction, the movement restriction member being interposed between the abradable seal and the abradable seal fixing part.

25. The compressor housing according to claim 24, wherein the abradable seal fixing part includes a press-fitting direction opposing surface that is opposed to a forward face of the abradable seal with respect to the press-fitting direction, and the movement restriction member is made up of a biasing member for biasing the abradable seal rearward in the press-fitting direction, the biasing member being interposed between the press-fitting direction opposing surface and the forward face of the abradable seal.

26. The compressor housing according to claim 24, wherein the movement restriction member is formed on an outer circumference of the abradable seal along a corner of the abradable seal fixing part between the grooved portion and the press-fitting recessed portion, and is made up of a bonding layer that bonds together the corner of the abradable seal fixing part and the outer circumference of the abradable seal.

27. The compressor housing according to claim 26, wherein the bonding layer is made up of an adhesive applied to a cut portion formed between the bulging portion and the press-fit abutting portion by cutting the abradable seal radially inwardly.

28. The compressor housing according to claim 27, wherein the cut portion is formed in the circumferential direction along the corner of the abradable seal fixing part.
